(19) United States
(12) Patent Application Publication
(10) Pub. No.: US 2026/0369204 A1
(43) Pub. Date: Nov. 19, 2026

(54) ARRAY SUBSTRATE, DRIVING METHOD AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Tao YANG, Beijing (CN); Dongchuan CHEN, Beijing (CN); Yanping LIAO, Beijing (CN); Yue YANG, Beijing (CN)

(21) Appl. No.: 19/148,281

(22) PCT Filed: Jun. 14, 2024
(86) PCT No.: PCT/CN2024/099158

§ 371 Date: Jul. 15, 2025

(30) Foreign Application Priority Data
Jul. 28, 2023 (CN) 202310943335.6

(51) Int. Cl. G09G 3/20

(52) U.S. Cl. CPC G09G 3/2074; G09G 3/2003; G09G 2320/0233; G09G 2320/0242

(57) ABSTRACT

An array substrate, a driving method and a display device are provided. The array substrate includes a plurality of scanning lines extending in a first direction, a plurality of data lines extending in a second direction, and a plurality of pixels. The pixel includes at least three subpixels having different colors; one of the plurality of scanning lines is arranged between two adjacent rows of subpixels, and one of the plurality of data lines is arranged between two adjacent columns of subpixels; in two adjacent rows of subpixels, two subpixels electrically coupled to a same data line have a same color, and the two subpixels are electrically coupled to different scanning lines; the subpixel includes a pixel electrode; and a length of the pixel electrode in the first direction is greater than a length of the pixel electrode in the second direction.

### CROSS-REFERENCE TO RELATED APPLICATIONS

This application is the U.S. national phase of PCT Application No. PCT/CN2024/099158 filed on Jun. 14, 2024, which claims a priority of the Chinese patent application No. 202310943335.6 filed on Jul. 28, 2023, the entire contents each of which are incorporated herein by reference in their entirety for all purposes.

### TECHNICAL FIELD

The present disclosure relates to the field of display technology, in particular to an array substrate, a driving method and a display device.

### BACKGROUND

In a conventional array substrate, a plurality of subpixels in one pixel is arranged in a row, two scanning lines are arranged between two adjacent rows of pixels, one data line is arranged between two adjacent columns of subpixels, and the subpixels coupled to each data line have 2 or more colors. A conventional design does not support a frequency doubling method, and in a frequency doubling mode, the adjacent subpixels coupled to a same data line have different colors, so a mixed color of the adjacent subpixels, rather than an expected, single color, is displayed, and thereby a display abnormality occurs for an image.

### SUMMARY

A main object of the present disclosure is to provide an array substrate, a driving method and a display device, so as to solve the problem in the related art where, in the frequency doubling mode, a mixed color of the adjacent subpixels, rather than an expected, single color is displayed and a display abnormality occurs for an image because the adjacent subpixels coupled to a same data line have different colors.

In one aspect, the present disclosure provides in some embodiments an array substrate, including a plurality of scanning lines extending in a first direction, a plurality of data lines extending in a second direction, and a plurality of pixels. The pixel includes at least three subpixels having different colors; one of the plurality of scanning lines is arranged between two adjacent rows of subpixels, and one of the plurality of data lines is arranged between two adjacent columns of subpixels; in two adjacent rows of subpixels, two subpixels electrically coupled to a same data line have a same color, and the two subpixels are electrically coupled to different scanning lines; the subpixel includes a pixel electrode; and a length of the pixel electrode in the first direction is greater than a length of the pixel electrode in the second direction.

In a possible embodiment of the present disclosure, a ratio of the length of the pixel electrode in the first direction to the length of the pixel electrode in the second direction is greater than 1 and smaller than or equal to 2.

In a possible embodiment of the present disclosure, a ratio of the length of the pixel electrodes in two adjacent rows and columns in the first direction to the length of the pixel electrodes in the two adjacent rows and columns in the second direction is greater than or equal to 1.2 and smaller than or equal to 1.8.

In a possible embodiment of the present disclosure, the pixel electrodes in at least two subpixels of a same pixel have different lengths in the first direction.

In a possible embodiment of the present disclosure, the pixel electrodes in the subpixels of different pixels having a same color have a same length in the first direction; and the pixel electrodes in the subpixels of different pixels having a same color have a same length in the second direction.

In a possible embodiment of the present disclosure, the pixel includes three subpixels having different colors; and two subpixels of the three subpixels of the pixel are arranged in a (2n−1)^{th} row, and a subpixel of the pixel other than the two subpixels is arranged in a (2n)^{th} row, where n is a positive integer.

In a possible embodiment of the present disclosure, a subpixel in the (2n−1)^{th} row and a (3m−2)^{th} column, a subpixel in the (2n−1)^{th} row and a (3m−1)^{th} column and a subpixel in the (2n)^{th} row and the (3m−2)^{th} column form a pixel; a subpixel in the (2n−1)^{th} row and a (3m)^{th} column, a subpixel in the (2n)^{th} row and the (3m−1)^{th} column and a subpixel in the (2n)^{th} row and the (3m)^{th} column form a pixel; the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n)^{th} row and the (3m−2)^{th} column is electrically coupled to a (2n)^{th} scanning line and a (3m−2)^{th} data line; and the subpixel in the (2n−1)^{th} row and the (3m)^{th} column is electrically coupled to the (2n−1)^{th} scanning line and a (3m+1)^{th} data line, the subpixel in the (2n)^{th} row and the (3m−1)^{th} column is electrically coupled to the (2n)^{th} scanning line and the (3m−1)^{th} data line, and the subpixel in the (2n)^{th} row and the (3m)^{th} column is electrically coupled to the (2n)^{th} scanning line and the (3m)^{th} data line, where m is a positive integer.

In a possible embodiment of the present disclosure, the subpixel in the (2n−1)^{th} row and the (3m−2)^{th} column is a red subpixel, the subpixel in the (2n−1)^{th} row and the (3m−1)^{th} column is a green subpixel, and the subpixel in the (2n)^{th} row and the (3m−2)^{th} column is a blue subpixel; and the subpixel in the (2n−1)^{th} row and the (3m)^{th} column is a blue subpixel, the subpixel in the (2n)^{th} row and the (3m−1)^{th} column is a red subpixel, and the subpixel in the (2n)^{th} row and the (3m)^{th} column is a green subpixel.

In a possible embodiment of the present disclosure, the subpixel in the (2n−1)^{th} row and the (3m−2)^{th} column is a red subpixel, the subpixel in the (2n−1)^{th} row and the (3m−1)^{th} column is a blue subpixel, and the subpixel in the (2n)^{th} row and the (3m−2)^{th} column is a green subpixel; and the subpixel in the (2n−1)^{th} row and the (3m)^{th} column is a green subpixel, the subpixel in the (2n)^{th} row and the (3m−1)^{th} column is a red subpixel, and the subpixel in the (2n)^{th} row and the (3m)^{th} column is a blue subpixel.

In a possible embodiment of the present disclosure, the subpixel in the (2n−1)^{th} row and the (3m−2)^{th} column is a blue subpixel, the subpixel in the (2n−1)^{th} row and the (3m−1)^{th} column is a red subpixel, and the subpixel in the (2n)^{th} row and the (3m−2)^{th} column is a green subpixel; and the subpixel in the (2n−1)^{th} row and the (3m)^{th} column is a green subpixel, the subpixel in the (2n)^{th} row and the (3m−1)^{th} column is a blue subpixel, and the subpixel in the (2n)^{th} row and the (3m)^{th} column is a red subpixel.

In a possible embodiment of the present disclosure, the at least three subpixels of the pixel having different colors are arranged in a same row.

In a possible embodiment of the present disclosure, the pixel includes three subpixels having different colors; a subpixel in a (2n−1)^{th} row and a (3m−2)^{th} column, a subpixel in the (2n−1)^{th} row and a (3m−1)^{th} column and a subpixel in the (2n−1)^{th} row and a (3m)^{th} column form a pixel; a subpixel in a (2n)^{th} row and the (3m−1)^{th} column, a subpixel in the (2n)^{th} row and the (3m)^{th} column and a subpixel in the (2n)^{th} row and a (3m+1)^{th} column form a pixel; the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n−1)^{th} row and the (3m)^{th} column is electrically coupled to the (2n−1)^{th} scanning line and a (3m+1)^{th} data line; and the subpixel in the (2n)^{th} row and the (3m−1)^{th} column is electrically coupled to a (2n)^{th} scanning line and the (3m−1)^{th} data line, the subpixel in the (2n)^{th} row and the (3m)^{th} column is electrically coupled to the (2n)^{th} scanning line and the (3m)^{th} data line, and the subpixel in the (2n)^{th} row and the (3m+1)^{th} column is electrically coupled to the (2n)^{th} scanning line and the (3m+1)^{th} data line, where n and m are both positive integers.

In a possible embodiment of the present disclosure, the subpixel in the (2n−1)^{th} row and the (3m−2)^{th} column has a same color as the subpixel in the (2n)^{th} row and the (3m−1)^{th} column; the subpixel in the (2n−1)^{th} row and the (3m−1)^{th} column has a same color as the subpixel in the (2n)^{th} row and the (3m)^{th} column; and the subpixel in the (2n−1)^{th} row and the (3m)^{th} has a same color as the subpixel in the (2n)^{th} row and the (3m+1)^{th} column.

In a possible embodiment of the present disclosure, the pixel includes three subpixels having different colors; a subpixel in a (2n−1)^{th} row and a (3m−2)^{th} column, a subpixel in the (2n−1)^{th} row and a (3m−1)^{th} column and a subpixel in the (2n−1)^{th} row and a (3m)^{th} column form a pixel; a subpixel in a (2n)^{th} row and the (3m)^{th} column, a subpixel in the (2n)^{th} row and a (3m+1)^{th} column and a subpixel in the (2n)^{th} row and a (3m+2)^{th} column form a pixel; the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n−1)^{th} row and the (3m)^{th} column is electrically coupled to the (2n−1)^{th} scanning line and a (3m+1)^{th} data line; and the subpixel in the (2n)^{th} row and the (3m)^{th} column is electrically coupled to a (2n)^{th} scanning line and the (3m)^{th} data line, the subpixel in the (2n)^{th} row and the (3m+1)^{th} column is electrically coupled to the (2n)^{th} scanning line and the (3m+1)^{th} data line, and the subpixel in the (2n)^{th} row and the (3m+2)^{th} column is electrically coupled to the (2n)^{th} scanning line and a (3m+2)^{th} data line, where n and m are both positive integers.

In a possible embodiment of the present disclosure, the subpixel in the (2n−1)^{th} row and the (3m−2)^{th} column has a same color as the subpixel in the (2n)^{th} row and the (3m)^{th} column; the subpixel in the (2n−1)^{th} row and the (3m−1)^{th} column has a same color as the subpixel in the (2n)^{th} row and the (3m+1)^{th} column; and the subpixel in the (2n−1)^{th} row and the (3m)^{th} has a same color as the subpixel in the (2n)^{th} row and the (3m+2)^{th} column.

In another aspect, the present disclosure provides in some embodiments a driving method, applied to the above-mentioned array substrate. A display period includes a plurality of driving stages arranged one after another. The driving method includes: at a (2n−1)^{th} driving stage, enabling a (2n−1)^{th} scanning line, and enabling subpixels in a (2n−1)^{th} row to receive a data voltage provided by corresponding data lines; and at a (2n)^{th} driving stage, enabling a (2n)^{th} scanning line, and enabling subpixels in a (2n)^{th} row to receive a data voltage provided by corresponding data lines, where n is a positive integer. At the (2n−1)^{th} driving stage, the data voltage provided by the data lines is a data voltage corresponding to the subpixels in the (2n−1)^{th} row, and at the (2n)^{th} driving stage, the data voltage provided by the data lines is a data voltage corresponding to the subpixels in the (2n)^{th} row.

In yet another aspect, the present disclosure provides in some embodiments a driving method, applied to the above-mentioned array substrate. The driving method includes applying scanning signals to a plurality of scanning lines, so that a (2n−1)^{th} scanning signal applied to a (2n−1)^{th} scanning line is the same as a (2n)^{th} scanning signal applied to a (2n)^{th} scanning line. An overlapping time period is included between an active voltage time period of the (2n)^{th} scanning signal and an active voltage time period of a (2n+1)^{th} scanning signal; and within the overlapping time period, the (2n−1)^{th} scanning line, the (2n)^{th} scanning line, a (2n+1)^{th} scanning line and a (2n+2)^{th} scanning line are enabled, and subpixels in a (2n−1)^{th} row, subpixels in a (2n)^{th} row, subpixels in a (2n+1)^{th} row and subpixels in a (2n+2)^{th} row receive a data voltage provided by corresponding data lines, where n is a positive integer.

In still yet another aspect, the present disclosure provides in some embodiments a driving method applied to the above-mentioned array substrate, including applying scanning signals to a plurality of scanning lines to control the plurality of scanning lines to be enabled sequentially within a display period. Within the display period, an overlapping time period and a non-overlapping period are included between active time periods of the scanning signals applied to at least two adjacent scanning lines in the plurality of scanning lines enabled sequentially; and a data voltage applied to a data line within at least a part of the overlapping time period is the same as a data voltage applied to the data line within at least a part of the non-overlapping time period.

In still yet another aspect, the present disclosure provides in some embodiments a display device including the above-mentioned array substrate.

According to the array substrate, the driving method and the display device in the embodiments of the present disclosure, in a frequency doubling mode, the adjacent subpixels coupled to a same data line have a same color, so as to improve image quality.

### BRIEF DESCRIPTION OF THE DRAWINGS

FIG. 1 is a schematic view showing a subpixel according to at least one embodiment of the present disclosure;

FIG. 2 is a schematic view showing an array substrate according to at least one embodiment of the present disclosure;

FIG. 3 is a schematic view showing the array substrate according to at least one embodiment of the present disclosure;

FIG. 4 is a schematic view showing the array substrate according to at least one embodiment of the present disclosure;

FIG. 5 is a schematic view showing the array substrate according to at least one embodiment of the present disclosure;

FIG. 6 is a schematic view showing the array substrate according to at least one embodiment of the present disclosure;

FIG. 7 is a schematic view showing the array substrate according to at least one embodiment of the present disclosure;

FIG. 8 is a schematic view showing the array substrate according to at least one embodiment of the present disclosure;

FIG. 9 is a schematic view showing the array substrate according to at least one embodiment of the present disclosure;

FIG. 10 is a schematic view showing the array substrate according to at least one embodiment of the present disclosure;

FIG. 11 is a schematic view showing the array substrate according to at least one embodiment of the present disclosure;

FIG. 12 is an oscillogram of scanning signals for a driving method according to at least one embodiment of the present disclosure;

FIG. 13 is an oscillogram of scanning signals for a driving method according to at least one embodiment of the present disclosure; and

FIG. 14 is an oscillogram of scanning signals for a driving method according to at least one embodiment of the present disclosure.

### DETAILED DESCRIPTION

The present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

All transistors adopted in the embodiments of the present disclosure may be thin film transistors, field effect transistors or any other elements having an identical characteristic. In order to differentiate two electrodes other than a gate electrode from each other, one of the two electrodes is called as first electrode and the other is called as second electrode.

In actual use, when the transistor is a thin film transistor or field effect transistor, the first electrode may be a drain electrode and the second electrode may be a source electrode, or the first electrode may be a source electrode and the second electrode may be a drain electrode.

The present disclosure provides in some embodiments an array substrate, which includes a plurality of scanning lines extending in a first direction, a plurality of data lines extending in a second direction, and a plurality of pixels. The pixel includes at least three subpixels having different colors; one of the plurality of scanning lines is arranged between two adjacent rows of subpixels, and one of the plurality of data lines is arranged between two adjacent columns of subpixels; in two adjacent rows of subpixels, two subpixels electrically coupled to a same data line have a same color, and the two subpixels are electrically coupled to different scanning lines; the subpixel includes a pixel electrode; and a length of the pixel electrode in the first direction is greater than a length of the pixel electrode in the second direction.

In a conventional array substrate, a plurality of subpixels in one pixel is arranged in a row, two scanning lines are arranged between two adjacent rows of pixels, one data line is arranged between two adjacent columns of subpixels, and the subpixels coupled to each data line have 2 or more colors. A conventional design does not support a frequency doubling method, and in a frequency doubling mode, the adjacent subpixels coupled to a same data line have different colors, so a mixed color of the adjacent subpixels, rather than an expected, single color, is displayed, and thereby a display abnormality occurs for an image.

Based on the above, in the array substrate provided in the embodiments of the present disclosure, two subpixels electrically coupled to a same data line have a same color, the two subpixels are electrically coupled to different scanning lines, and the length of the pixel electrode in the first direction is greater than the length of the pixel electrode in the second direction. In a frequency doubling mode, the adjacent subpixels coupled to a same data line have a same color, so as to improve image quality.

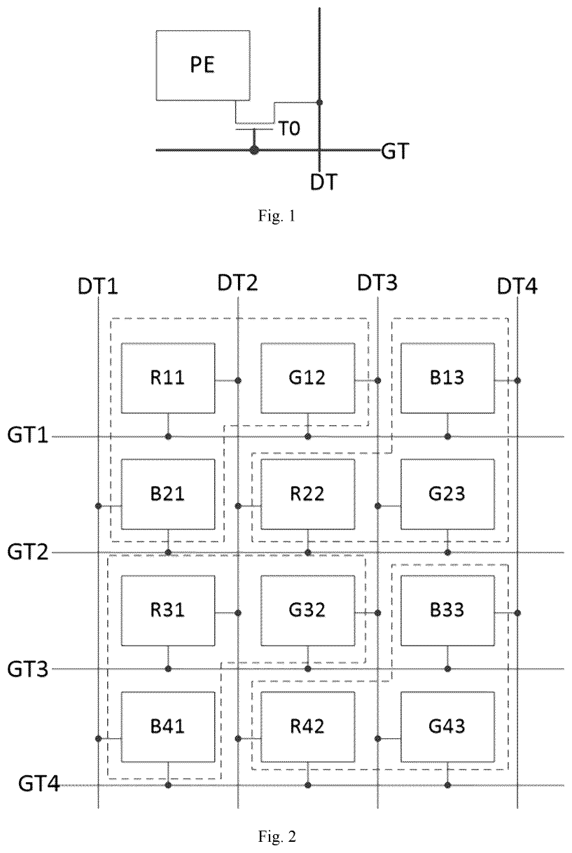

In at least one embodiment of the present disclosure, as shown in FIG. 1, the subpixel includes a pixel electrode PE and a thin film transistor T0. A gate electrode of the thin film transistor T0 is electrically coupled to the scanning line GT, a first electrode of the thin film transistor T0 is electrically coupled to the pixel electrode PE, and a second electrode of the thin film transistor T0 is electrically coupled to the data line DT. In a case that that thin film transistor T0 is turned on under the control of a scanning signal provided by the scanning line GT, the data line DT applies a data voltage to the pixel electrode PE.

In the conventional array substrate, a ratio of the length of the pixel electrode in the first direction to the length of the pixel electrode in the second direction is about ⅓. However, in the embodiments of the present disclosure, the length of the pixel electrode in the first direction is greater than the length of the pixel electrode in the second direction.

In a possible embodiment of the present disclosure, a ratio of the length of the pixel electrode in the first direction to the length of the pixel electrode in the second direction is greater than 1 and smaller than or equal to 2.

For example, the ratio of the length of the pixel electrode in the first direction to the length of the pixel electrode in the second direction is, but not limited to, 4/3.

In at least one embodiment of the present disclosure, a ratio of the length of the pixel electrodes in two adjacent rows and columns in the first direction to the length of the pixel electrodes in the two adjacent rows and columns in the second direction is greater than or equal to 1.2 and smaller than or equal to 1.8.

During the implementation, the ratio of the length of the pixel electrodes in two adjacent rows and columns in the first direction to the length of the pixel electrodes in the two adjacent rows and columns in the second direction is, but not limited to, about 1.5.

In a possible embodiment of the present disclosure, the pixel electrodes in at least two subpixels of a same pixel have different lengths in the first direction, so as to improve a display contrast of the subpixels having different colors.

In a possible embodiment of the present disclosure, the pixel electrodes in the subpixels of different pixels having a same color have a same length in the first direction, and the pixel electrodes in the subpixels of different pixels having a same color have a same length in the second direction, so as to improve the display uniformity of the subpixels having the same color.

In at least one embodiment of the present disclosure, the pixel includes three subpixels having different colors; and two subpixels of the three subpixels of the pixel are arranged in a (2n−1)^{th} row, and a subpixel of the pixel other than the two subpixels is arranged in a (2n)^{th} row, where n is a positive integer.

During the implementation, the length of the pixel electrode in the subpixel in the first direction is twice the length of the conventional pixel electrode in the first direction, and the length of the pixel electrode in the subpixel in the second direction is ½ of the length of the conventional pixel electrode in the second direction. In a case that the pixel includes three subpixels, two subpixels of the pixel are arranged in the (2n−1)^{th} row, a subpixel of the pixel other than the two subpixels is arranged in the (2n)^{th} row, the subpixels in the two adjacent rows and columns form a rectangle, and a size of the rectangle is the same as a size of a rectangle consisting of the pixels in two adjacent rows and columns in the related art. Hence, in at least one embodiment of the present disclosure, a pixel resolution is the same as that in the related art.

In at least one embodiment of the present disclosure, one scanning line is arranged between two adjacent rows of subpixels, and one row of pixels include two rows of subpixels, so one row of pixels are electrically coupled to two scanning lines. A pixel structure in the array substrate is a dual-gate pixel structure.

In at least one embodiment of the present disclosure, one data line is arranged between two adjacent columns of subpixels, and two columns of pixels occupy a length of three columns of subpixels in the second direction, so two columns of pixels are electrically coupled to three data lines. In the related art, there is one data line for every two columns of subpixels, and two columns of pixels include three columns of subpixels, so two columns of pixels are also electrically coupled to three data lines.

In a possible embodiment of the present disclosure, the first direction is a horizontal direction, and the second direction is a vertical direction.

In at least one embodiment of the present disclosure, a subpixel in the (2n−1)^{th} row and a (3m−2)^{th} column, a subpixel in the (2n−1)^{th} row and a (3m−1)^{th} column and a subpixel in the (2n)^{th} row and the (3m−2)^{th} column form a pixel; a subpixel in the (2n−1)^{th} row and a (3m)^{th} column, a subpixel in the (2n)^{th} row and the (3m−1)^{th} column and a subpixel in the (2n)^{th} row and the (3m)^{th} column form a pixel; the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n)^{th} row and the (3m−2)^{th} column is electrically coupled to a (2n)^{th} scanning line and a (3m−2)^{th} data line; and the subpixel in the (2n−1)^{th} row and the (3m)^{th} column is electrically coupled to the (2n−1)^{th} scanning line and a (3m+1)^{th} data line, the subpixel in the (2n)^{th} row and the (3m−1)^{th} column is electrically coupled to the (2n)^{th} scanning line and the (3m−1)^{th} data line, and the subpixel in the (2n)^{th} row and the (3m)^{th} column is electrically coupled to the (2n)^{th} scanning line and the (3m)^{th} data line, where m is a positive integer.

In a possible embodiment of the present disclosure, the subpixel in the (2n−1)^{th} row and the (3m−2)^{th} column is a red subpixel, the subpixel in the (2n−1)^{th} row and the (3m−1)^{th} column is a green subpixel, and the subpixel in the (2n)^{th} row and the (3m−2)^{th} column is a blue subpixel; and the subpixel in the (2n−1)^{th} row and the (3m)^{th} column is a blue subpixel, the subpixel in the (2n)^{th} row and the (3m−1)^{th} column is a red subpixel, and the subpixel in the (2n)^{th} row and the (3m)^{th} column is a green subpixel.

In a possible embodiment of the present disclosure, the subpixel in the (2n−1)^{th} row and the (3m−2)^{th} column is a red subpixel, the subpixel in the (2n−1)^{th} row and the (3m−1)^{th} column is a blue subpixel, and the subpixel in the (2n)^{th} row and the (3m−2)^{th} column is a green subpixel; and the subpixel in the (2n−1)^{th} row and the (3m)^{th} column is a green subpixel, the subpixel in the (2n)^{th} row and the (3m−1)^{th} column is a red subpixel, and the subpixel in the (2n)^{th} row and the (3m)^{th} column is a blue subpixel.

In a possible embodiment of the present disclosure, the subpixel in the (2n−1)^{th} row and the (3m−2)^{th} column is a blue subpixel, the subpixel in the (2n−1)^{th} row and the (3m−1)^{th} column is a red subpixel, and the subpixel in the (2n)^{th} row and the (3m−2)^{th} column is a green subpixel; and the subpixel in the (2n−1)^{th} row and the (3m)^{th} column is a green subpixel, the subpixel in the (2n)^{th} row and the (3m−1)^{th} column is a blue subpixel, and the subpixel in the (2n)^{th} row and the (3m)^{th} column is a red subpixel.

As shown in FIG. 2, a red subpixel R11 in a first row and a first column, a green subpixel G12 in the first row and a second column and a blue subpixel B21 in a second row and the first column form a pixel; a blue subpixel B13 in the first row and a third column, a red subpixel R22 in the second row and the second column and a green subpixel G23 in the second row and the third column form a pixel; a red subpixel R31 in a third row and the first column, a green subpixel G32 in the third row and the third column and a blue subpixel B41 in a fourth row and the first column forms a pixel; and a blue subpixel B33 in the third row and the third column, a red subpixel R42 in the fourth row and the second column and a green subpixel G43 in the fourth row and the third column form a pixel. B21 and B41 are electrically coupled to a first data line DT1, R11 and R31 are electrically coupled to a second data line DT2, G12 and G32 are electrically coupled to a third data line DT3, and B31 and B33 are electrically coupled to a fourth data line DT4. R11, G12 and B13 are electrically coupled to a first scanning line GT1, B21, R22 and G23 are electrically coupled to a second scanning line GT2, R31, G32 and B33 are electrically coupled to a third scanning line GT3, and B41, R42 and G43 are electrically coupled to a fourth scanning line GT4.

In at least one embodiment as shown in FIG. 2, the subpixels electrically coupled to the first data line DT1 are all blue subpixels, the subpixels electrically coupled to the second data line DT2 are all red subpixels, the subpixels electrically coupled to the third data line DT3 are all green subpixels, and the subpixels electrically coupled to the fourth data line DT4 are all blue subpixels.

In at least one embodiment as shown in FIG. 2, the length of the pixel electrode in each subpixel in the horizontal direction is twice the length of the pixel electrode in the conventional pixel electrode in the horizontal direction, and the length of the pixel electrode in each subpixel in the vertical direction is ½ of the length of the conventional pixel electrode in the vertical direction. In a possible embodiment of the present disclosure, a ratio of the length of the pixel electrode in the first direction to the length of the pixel electrode in the second direction is 4/3. It should be appreciated that, in the embodiments of the present disclosure, in a case that the pixel electrode is a plate-like electrode, the length of the pixel electrode refers to a length of a contour of the plate-like electrode; in a case that the pixel electrode includes a slit and the pixel electrode still has a closed peripheral contour, the length of the pixel electrode refers to a length of the closed contour of the pixel electrode; and in a case that the pixel electrode includes a plurality of branch electrodes and the pixel electrode does not have a closed peripheral contour, the length of the pixel electrode refers to a length of a connecting line formed through connecting ends of the branch electrodes close to a periphery of the pixel electrode. The above also applies to a width of the pixel electrode, which will not be particularly defined herein.

In at least one embodiment as shown in FIG. 2, the lengths of the pixel electrodes in the subpixels in the horizontal direction are the same, and the lengths of the pixel electrodes in the subpixels in the vertical direction are the same, so as to improve the display uniformity.

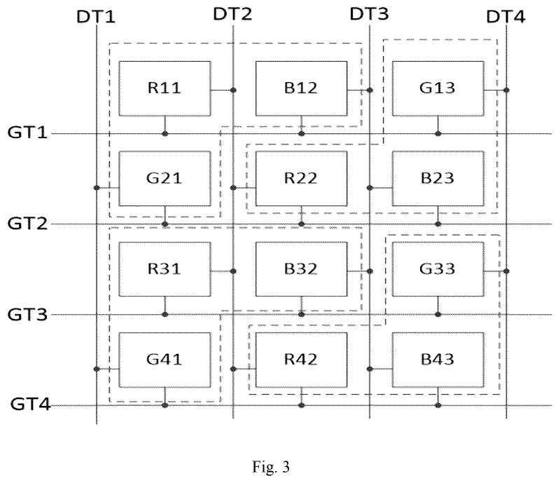

As shown in FIG. 3, a red subpixel R11 in a first row and a first column, a blue subpixel B12 in the first row and a second row and a green subpixel G21 in a second row and the first column form a pixel; a green subpixel G13 in the first row and a third column, a red subpixel R22 in the second row and the second column and a blue subpixel B23 in the second row and the third column form a pixel; a red subpixel R31 in a third row and the first column, a blue subpixel B32 in the third row and the second column and a green subpixel G41 in a fourth row and the first column form a pixel; and a green subpixel G33 in the third row and the third column, a red subpixel R42 in the fourth row and the second column and a blue subpixel B43 in the fourth row and a third column for a pixel. G21 and G41 are both electrically coupled to a first data line DT1, R11 and R31 are both electrically coupled to a second data line DT2, B12 and B31 are both electrically coupled to a third data line DT3, and G31 and G33 are both electrically coupled to a fourth data line DT4. R11, B12 and G13 are electrically coupled to a first scanning line GT1, G21, R22 and B23 are electrically coupled to a second scanning line GT2, R31, B32 and G33 are electrically coupled to a third scanning line GT3, and G41, R42 and B43 are electrically coupled to a fourth scanning line GT4.

In at least one embodiment as shown in FIG. 3, the length of the pixel electrode in each subpixel in the horizontal direction is twice the length of the conventional pixel electrode in the horizontal direction, and the length of the pixel electrode in each subpixel in the vertical direction is ½ of the length of the conventional pixel electrode in the vertical direction. In a possible embodiment of the present disclosure, a ratio of the length of the pixel electrode in the first direction to the length of the pixel electrode in the second direction is 4/3.

In at least one embodiment as shown in FIG. 3, the lengths of the pixel electrodes in the subpixels in the horizontal direction are the same, and the lengths of the pixel electrodes in the subpixels in the vertical direction are the same, so as to improve the display uniformity.

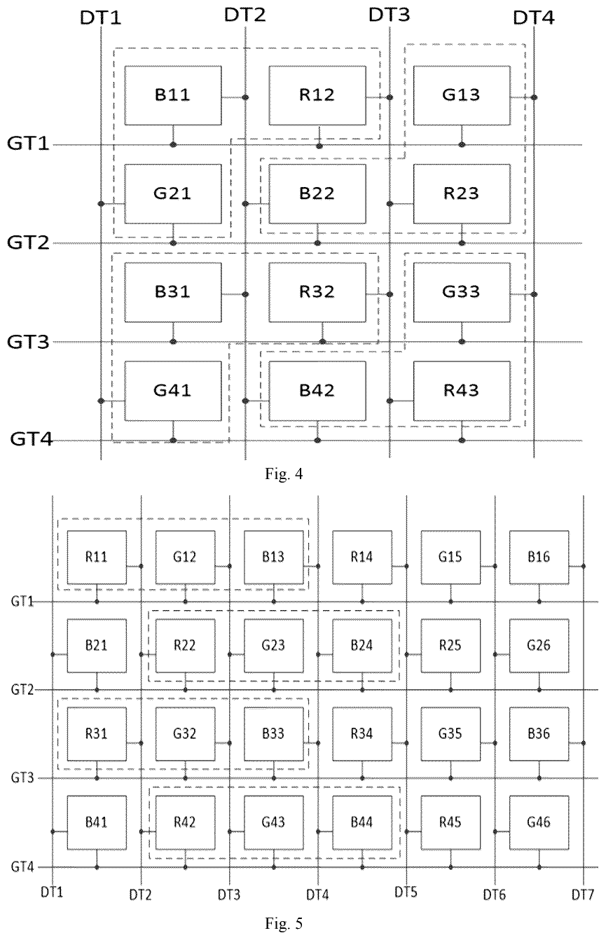

As shown in FIG. 4, a blue subpixel B11 in a first row and a first column, a red subpixel R12 in the first row and a second column and a green subpixel G21 in a second row and the first column form a pixel; a green subpixel G13 in the first row and a third column, a blue subpixel B22 in the second row and the second column and a red subpixel R23 in the second row and the third column form a pixel; a blue subpixel B31 in a third row and the first column, a red subpixel R32 in the third row and the second column and a green subpixel G41 in a fourth row and the first column form a pixel; and a green subpixel G33 in the third row and the third column, a blue subpixel B42 in the fourth row and the second column and a red subpixel R43 in the fourth row and the third column form a pixel. G21 and G41 are both electrically coupled to a first data line DT1, B11 and B31 are both electrically coupled to a second data line DT2, R12 and R32 are both electrically coupled to a third data line DT3, and G31 and G33 are both electrically coupled to a fourth data line DT4. B11, R12 and G13 are electrically coupled to a first scanning line GT1, G21, B22 and R23 are electrically coupled to a second scanning line GT2, B31, R32 and G33 are electrically coupled to a third scanning line GT3, and G41, B42 and R43 are electrically coupled to a fourth scanning line GT4.

In at least one embodiment of the present disclosure, a basis for forming a pixel using three subpixels having different colors includes that, after corresponding data voltages applied to the three subpixels having different colors, light emitted by the three subpixels has a brightness value corresponding to a predetermined grayscale, and the light emitted by the three subpixels is combined to form white light. For example, referring to FIG. 4, a pixel in FIG. 4 is controlled by two gate lines, and in a case that the pixel needs to emit light, the two gate lines are enabled, and data voltages are applied to the three subpixels having different colors.

In at least one embodiment as shown in FIG. 4, the length of the pixel electrode in each subpixel in the horizontal direction is twice the length of the conventional pixel electrode in the horizontal direction, and the length of the pixel electrode in each subpixel in the vertical direction is ½ of the length of the conventional pixel electrode in the vertical direction. In a possible embodiment of the present disclosure, a ratio of the length of the pixel electrode in the first direction to the length of the pixel electrode in the second direction is 4/3.

In at least one embodiment as shown in FIG. 4, the lengths of the pixel electrodes in the subpixels in the horizontal direction are the same, and the lengths of the pixel electrodes in the subpixels in the vertical direction are the same, so as to improve the display uniformity.

In at least one embodiment of the present disclosure, the at least three subpixels of the pixel having different colors are arranged in a same row.

During the implementation, the at least three subpixels of the pixel having different colors are arranged in a same row, and two pixels are offset horizontally from each other by a width of one subpixel or a width of two subpixels.

In at least one embodiment of the present disclosure, the pixel includes three subpixels having different colors; a subpixel in a (2n−1)^{th} row and a (3m−2)^{th} column, a subpixel in the (2n−1)^{th} row and a (3m−1)^{th} column and a subpixel in the (2n−1)^{th} row and a (3m)^{th} column form a pixel; a subpixel in a (2n)^{th} row and the (3m−1)^{th} column, a subpixel in the (2n)^{th} row and the (3m)^{th} column and a subpixel in the (2n)^{th} row and a (3m+1)^{th} column form a pixel; the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n−1)^{th} row and the (3m)^{th} column is electrically coupled to the (2n−1)^{th} scanning line and a (3m+1)^{th} data line; and the subpixel in the (2n)^{th} row and the (3m−1)^{th} column is electrically coupled to a (2n)^{th} scanning line and the (3m−1)^{th} data line, the subpixel in the (2n)^{th} row and the (3m)^{th} column is electrically coupled to the (2n)^{th} scanning line and the (3m)^{th} data line, and the subpixel in the (2n)^{th} row and the (3m+1)^{th} column is electrically coupled to the (2n)^{th} scanning line and the (3m+1)^{th} data line, where n and m are both positive integers.

In a possible embodiment of the present disclosure, the subpixel in the (2n−1)^{th} row and the (3m−2)^{th} column has a same color as the subpixel in the (2n)^{th} row and the (3m−1)^{th} column; the subpixel in the (2n−1)^{th} row and the (3m−1)^{th} column has a same color as the subpixel in the (2n)^{th} row and the (3m)^{th} column; and the subpixel in the (2n−1)^{th} row and the (3m)^{th} has a same color as the subpixel in the (2n)^{th} row and the (3m+1)^{th} column.

As shown in FIG. 5, a red subpixel R11 in a first row and a first column, a green subpixel G12 in the first row and a second column and a blue subpixel B13 in the first row and a third column form a pixel; a red subpixel R22 in a second row and the second column, a green subpixel G23 in the second row and the third column and a blue subpixel B24 in the second row and a fourth column form a pixel; a red subpixel R31 in a third row and the first column, a green subpixel G32 in the third row and the second column and a blue subpixel B33 in the third row and the third column form a pixel; a red subpixel R34 in the third row and the fourth column, a green subpixel G35 in the third row and a fifth column and a blue subpixel B36 in the third row and a sixth column form a pixel; and a red subpixel R42 in a fourth row and the second column, a green subpixel G43 in the fourth row and the third column and a blue subpixel B44 in the fourth row and the fourth column form a pixel. B21 and B41 are both electrically coupled to a first data line DT1, R11, R22, R31 and R42 are electrically coupled to a second data line DT2, G12, G23, G32 and G43 are electrically coupled to a third data line DT3, B13, B24, B33 and B44 are electrically coupled to a fourth data line DT4, R14, R25, R34 and R45 are electrically coupled to a fifth data line DT5, G15, G26, G35 and G46 are electrically coupled to a sixth data line DT6, and B16 and B36 are electrically coupled to a seventh data line DT7.

R14 represents a red subpixel in the first row and the fourth column, G15 represents a green subpixel in the first row and the fifth column, B16 represents a blue subpixel in the first row and the sixth column, B21 represents a blue subpixel in the second row and the first column, R25 represents a red subpixel in the second row and the fifth column, G26 represents a green subpixel in the second row and the sixth column, B41 represents a blue subpixel in the fourth row and the first column, R45 represents a red subpixel in the fourth row and the fifth column, and G46 represents a green subpixel in the fourth row and the sixth column.

In at least one embodiment as shown in FIG. 5, the length of the pixel electrode in each subpixel in the horizontal direction is twice the length of the conventional pixel electrode in the horizontal direction, and the length of the pixel electrode in each subpixel in the vertical direction is ½ of the length of the pixel electrode in the conventional pixel electrode in the vertical direction.

In at least one embodiment in FIG. 5, the lengths of the pixel electrodes in the subpixels in the horizontal direction are the same, and the lengths of the pixel electrodes in the subpixels in the vertical direction are the same, so as to improve the display uniformity.

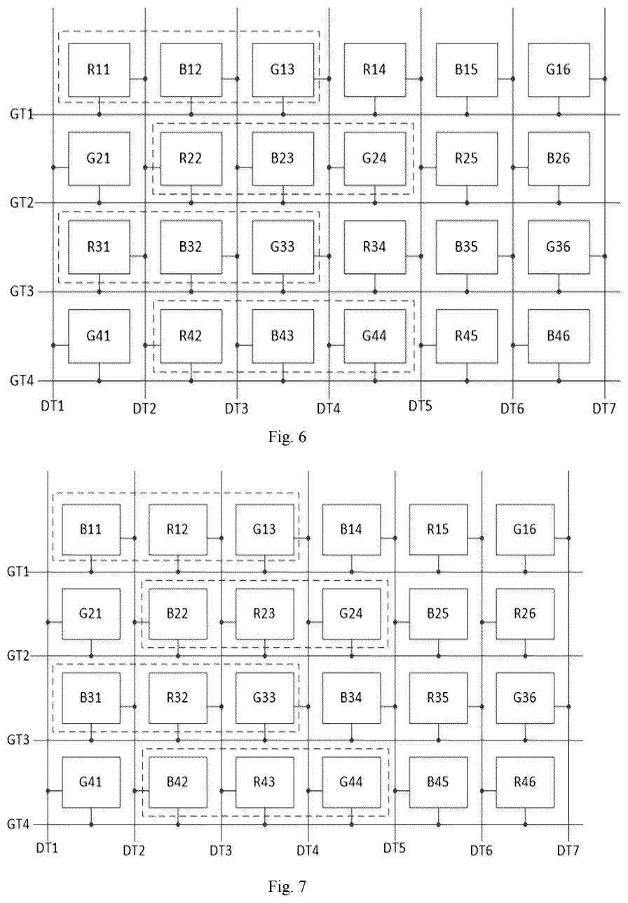

As shown in FIG. 6, R11 in a first row and a first column, B12 in the first row and a second column, and a green subpixel G13 in the first row and a third column form a pixel; a red subpixel R22 in a second row and the second column, a blue subpixel B23 in the second row and the third column and a green subpixel G24 in the second row and a fourth column form a pixel; a red subpixel R31 in a third row and the first column, a blue subpixel B32 in the third row and the second column and a green subpixel G33 in the third row and the third column form a pixel; and a red subpixel R42 in a fourth row, a blue subpixel B43 in the fourth row and the third column, and a green subpixel G44 in the fourth row and the fourth column form a pixel. G21 and G41 are both electrically coupled to a first data line DT1, R11, R22, R31 and R42 are electrically coupled to a second data line DT2, B12, B23, B32 and B43 are electrically coupled to a third data line DT3, G13, G24, G33 and G44 are electrically coupled to a fourth data line DT4, R14, R25, R34 and R45 are electrically coupled to a fifth data line DT5, B15, B26, B35 and B46 are electrically coupled to a sixth data line DT6, and G16 and G36 are electrically coupled to a seventh data line DT7.

R14 represents a red subpixel in the first row and the fourth column, B15 represents a blue subpixel in the first row and the fifth column, G16 represents a green subpixel in the first row and the sixth column, G21 represents a green subpixel in the second row and the first column, R25 represents a red subpixel in the second row and the fifth column, B26 represents a blue subpixel in the second row and the sixth column, R34 represents a red subpixel in the third row and the fourth column, B35 represents a blue subpixel in the third row and the fifth column, G36 represents a green subpixel in the third row and the sixth column, G41 represents a green subpixel in the fourth row and the first column, R45 represents a red subpixel in the fourth row and the fifth column, and B46 represents a blue subpixel in the fourth row and the sixth column.

In at least one embodiment as shown in FIG. 6, the length of the pixel electrode in each subpixel in the horizontal direction is twice the length of the pixel electrode in the conventional pixel electrode in the horizontal direction, and the length of the pixel electrode in each subpixel in the vertical direction is ½ of the length of the pixel electrode in the conventional pixel electrode in the vertical direction.

In at least one embodiment as shown in FIG. 6, the lengths of the pixel electrodes in the subpixels in the horizontal direction are the same, the lengths of the pixel electrodes in the subpixels in the vertical direction are the same, so as to improve the display uniformity.

As shown in FIG. 7, a blue subpixel B11 in a first row and a first column, a red subpixel R12 in the first row and a second column and a green subpixel G13 in the first row and a third column form a pixel; a blue subpixel B22 in a second row and the second column, a red subpixel R23 in the second row and the third column, and a green subpixel G24 in the second row and a fourth column form a pixel; a blue subpixel B31 in a third row and the first column, a red subpixel R32 in the third row and the second column and a green subpixel G33 in the third row and the third column form a pixel; a blue subpixel B42 in a fourth row and the second column, a red subpixel R43 in the fourth row and the third column, and a green subpixel G44 in the fourth row and the fourth column form a pixel. G21 and G41 are both electrically coupled to a first data line DT1, B11, B22, B31 and B42 are electrically coupled to a second data line DT2, R12, R23, R32 and R43 are electrically coupled to a third data line DT3, G13, G24, G33 and G44 are electrically coupled to a fourth data line DT4, B14, B25, B34 and B45 are electrically coupled to a fifth data line DT5, R15, R26, R35 and R46 are electrically coupled to a sixth data line DT6, and G16 and G36 are electrically coupled to a seventh data line DT7.

The subpixels in the first row are electrically coupled to a first scanning line GT1, the subpixels in the second row are electrically coupled to a second scanning line GT2, the subpixels in the third row are electrically coupled to a third scanning line GT3, and the subpixels in the fourth row are electrically coupled to a fourth scanning line GT4.

B14 represents a blue subpixel in the first row and the fourth column, R15 represents a red subpixel in the first row and the fifth column, G16 represents a green subpixel in the first row and the sixth column, G21 represents a green subpixel in the second row and the first column, B25 represents a blue subpixel in the second row and the fifth column, R26 represents a red subpixel in the second row and the sixth column, B34 represents a blue subpixel in the third row and the fourth column, R35 represents a red subpixel in the third row and the fifth column, B36 represents a blue subpixel in the third row and the sixth column, G41 represents a green subpixel in the fourth row and the first column, B45 represents a blue subpixel in the fourth row and the fifth column, and R46 represents a red subpixel in the fourth row and the sixth column.

In at least one embodiment as shown in FIG. 7, the length of the pixel electrode in each subpixel in the horizontal direction is twice the length of the conventional pixel electrode in the horizontal direction, and the length of the pixel electrode in each subpixel in the vertical direction is ½ of the length of the conventional pixel electrode in the vertical direction.

In at least one embodiment as shown in FIG. 7, the lengths of the pixel electrodes in the subpixels in the horizontal direction are the same, and the lengths of the pixel electrodes in the subpixels in the vertical direction are the same, so as to improve the display uniformity.

In at least one embodiment of the present disclosure, the pixel includes three subpixels having different colors; a subpixel in a (2n−1)^{th} row and a (3m−2)^{th} column, a subpixel in the (2n−1)^{th} row and a (3m−1)^{th} column and a subpixel in the (2n−1)^{th} row and a (3m)^{th} column form a pixel; a subpixel in a (2n)^{th} row and the (3m)^{th} column, a subpixel in the (2n)^{th} row and a (3m+1)^{th} column and a subpixel in the (2n)^{th} row and a (3m+2)^{th} column form a pixel; the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n−1)^{th} row and the (3m)^{th} column is electrically coupled to the (2n−1)^{th} scanning line and a (3m+1)^{th} data line; and the subpixel in the (2n)^{th} row and the (3m)^{th} column is electrically coupled to a (2n)^{th} scanning line and the (3m)^{th} data line, the subpixel in the (2n)^{th} row and the (3m+1)^{th} column is electrically coupled to the (2n)^{th} scanning line and the (3m+1)^{th} data line, and the subpixel in the (2n)^{th} row and the (3m+2)^{th} column is electrically coupled to the (2n)^{th} scanning line and a (3m+2)^{th} data line, where n and m are both positive integers.

In a possible embodiment of the present disclosure, the subpixel in the (2n−1)^{th} row and the (3m−2)^{th} column has a same color as the subpixel in the (2n)^{th} row and the (3m)^{th} column; the subpixel in the (2n−1)^{th} row and the (3m−1)^{th} column has a same color as the subpixel in the (2n)^{th} row and the (3m+1)^{th} column; and the subpixel in the (2n−1)^{th} row and the (3m)^{th} has a same color as the subpixel in the (2n)^{th} row and the (3m+2)^{th} column.

During the implementation, the at last three subpixels in the pixel having different colors are arranged in a same row, and two pixels are horizontally offset from each other by a width of two subpixels.

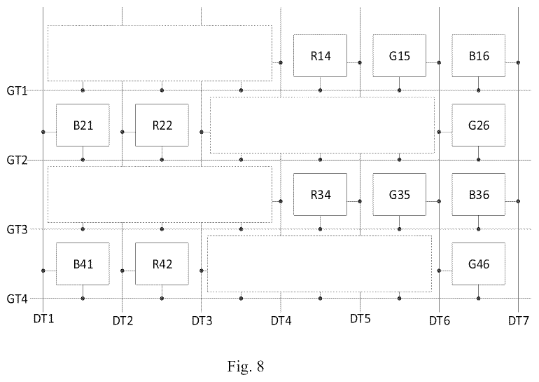

As shown in FIG. 8, a red subpixel R11 in a first row and a first column, a green subpixel G12 in the first row and a second column and a blue subpixel B13 in the first row and a third column form a pixel; a green subpixel G23 in a second row and the third column, a blue subpixel B24 in the second row and a fourth column and a red subpixel R25 in the second row and a fifth column form a pixel; a red subpixel R31 in a third row and the first column, a green subpixel G32 in the third row and the second column and a blue subpixel B33 in the third row and the third column form a pixel; and a green subpixel G43 in a fourth row and the third column, a blue subpixel B44 in the fourth row and the fourth column and a red subpixel R45 in the fourth row and the fifth column form a pixel. B21 and B41 are electrically coupled to a first data line DT1; R11, R22, R31 and R42 are electrically coupled to a second data line DT2; G12, G23, G32 and G43 are electrically coupled to a third data line DT3; B13, B24, B33 and B44 are electrically coupled to a fourth data line DT4; R14, R25, R34 and R45 are electrically coupled to a fifth data line DT5; G15, G26, G35 and G46 are electrically coupled to a sixth data line DT6; and B16 and B36 are electrically coupled to a seventh data line DT7.

The subpixels in the first row are all electrically coupled to a first scanning line GT1, the subpixels in the second row are all electrically coupled to a second scanning line GT2, the subpixels in the third row are all electrically coupled to a third scanning line GT3, and the subpixels in the fourth row are all electrically coupled to a fourth scanning line GT4.

In at least one embodiment as shown in FIG. 8, R14 represents a red subpixel in the first row and the fourth column, G15 represents a green subpixel in the first row and the fifth column, B16 represents a blue subpixel in the first row and the sixth column, B21 represents a blue subpixel in the second row and the first column, R22 represents a red subpixel in the second row and the second column, G26 represents a green subpixel in the second row and the sixth column, R34 represents a red subpixel in the third row and the fourth column, G35 represents a green subpixel in the third row and the fifth column, B36 represents a blue subpixel in the third row and the sixth column, B41 represents a blue subpixel in the fourth row and the first column, R42 represents a red subpixel in the fourth row and the second column, and G46 represents a green subpixel in the fourth row and the sixth column.

In at least one embodiment as shown in FIG. 8, the length of the pixel electrode in each subpixel in the horizontal direction is twice of length of the conventional pixel electrode in the horizontal direction, and the length of the pixel electrode in each subpixel in the vertical direction is ½ of the length of the conventional pixel electrode in the vertical direction.

In at least one embodiment as shown in FIG. 8, the lengths of the pixel electrodes in the subpixels in the horizontal direction are the same, and the lengths of the pixel electrodes in the subpixels in the vertical direction are the same, so as to improve the display uniformity.

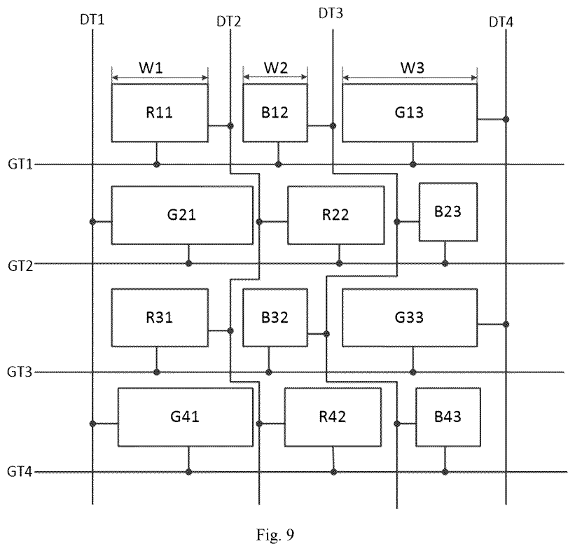

As shown in FIG. 9, a red subpixel R11 in a first row and a first column, a blue subpixel B12 in the first row and a second column and a green subpixel G21 in a second row and the first column form a pixel; a green subpixel G13 in the first row and a third column, a red subpixel R22 in the second row and the second column and a blue subpixel B23 in the second row and the third column form a pixel; a red subpixel R31 in a third row and the first column, a blue subpixel B32 in the third row and the second column and a green subpixel G41 in a fourth row and the first column form a pixel; and a green subpixel G33 in the third row and the third column, a red subpixel R42 in the fourth row and the second column and a blue subpixel B43 in the fourth row and the third column form a pixel. G21 and G41 are both electrically coupled to a first data line DT1, R11 and R31 are both electrically coupled to a second data line DT2, B12 and B32 are both electrically coupled to a third data line DT3, and G31 and D33 are both electrically coupled to a fourth data line DT4. R11, B12 and G13 are electrically coupled to a first scanning line GT1, G21, R22 and B23 are electrically coupled to a second scanning line GT2, R31, B32 and G33 are electrically coupled to a third scanning line GT3, and G41, R42 and B43 are electrically coupled to a fourth scanning line GT4.

In at least one embodiment as shown in FIG. 9, a length of the pixel electrode in each green subpixel in the horizontal direction is greater than a length of the pixel electrode in each red subpixel in the horizontal direction, and the length of the pixel electrode in each red subpixel in the horizontal direction is greater than a length of the pixel electrode in each blue subpixel in the horizontal direction.

In the pixels, the lengths of the pixel electrodes in the red subpixels in the horizontal direction are the same, the lengths of the pixel electrodes in the green subpixels in the horizontal direction are the same, the lengths of the pixel electrodes in the blue subpixels in the horizontal direction are the same, the lengths of the pixel electrodes in the red subpixels in the vertical direction are the same, the lengths of the pixel electrodes in the green subpixels in the vertical direction are the same, and the lengths of the pixel electrodes in the blue subpixels in the vertical direction are the same, so as to improve the display uniformity of the subpixels having a same color.

In at least one embodiment as shown in FIG. 9, a first length W1 represents a length of the pixel electrode in R11 in the horizontal direction, a second length W2 represents a length of the pixel electrode in B12 in the horizontal direction, and a third length W3 represents a length of the pixel electrode in G13 in the horizontal direction.

In at least one embodiment as shown in FIG. 9, W3 is greater than W1, and W1 is greater than W2. However, the present disclosure is not limited thereto.

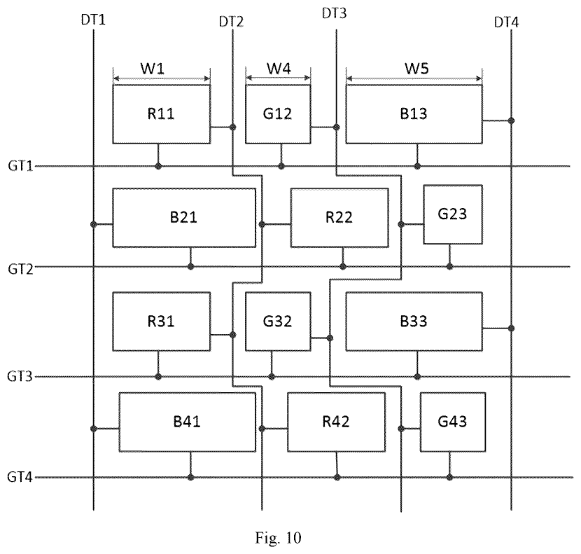

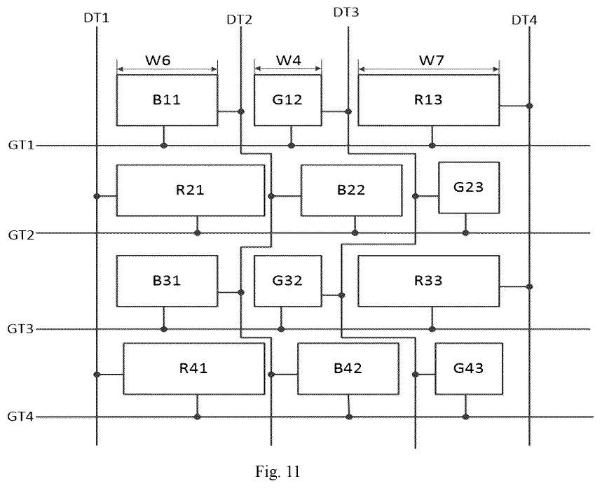

As shown in FIG. 10, a red subpixel R11 in a first row and a first column, a green subpixel G12 in the first row and a second column and a blue subpixel B21 in a second row and the first column form a pixel; a blue subpixel B13 in the first row and a third column, a red subpixel R22 in the second row and the second column and a green subpixel G23 in the second row and the third column form a pixel; a red subpixel R31 in a third row and the first column, a green subpixel G32 in the third row and the second column and a blue subpixel B41 in a fourth row and the first column form a pixel; and a blue subpixel B33 in the third row and the third column, a red subpixel R42 in the fourth row and the second column and a green subpixel G43 in the fourth row and the third column form a pixel. B21 and B41 are both electrically coupled to a first data line DT1, R11, R22, R31 and R42 are electrically coupled to a second data line DT2, G12, G23, G32 and G43 are electrically coupled to a third data line DT3, and B31 and B33 are both electrically coupled to a fourth data line DT4. R11, G12 and B13 are electrically coupled to a first scanning line GT1, B21, R22 and G23 are electrically coupled to a second scanning line GT2, R31, G32 and B33 are electrically coupled to a third scanning line GT3, and B41, R42 and G43 are electrically coupled to a fourth scanning line GT4.

In at least one embodiment as shown in FIG. 10, a length of the pixel electrode in each blue subpixel in the horizontal direction is greater than a length of the pixel electrode in each red subpixel in the horizontal direction, and the length of the pixel electrode in each red subpixel in the horizontal direction is greater than a length of the pixel electrode in each green subpixel in the horizontal direction.

In the pixels, the lengths of the pixel electrodes in the red subpixels in the horizontal direction are the same, the lengths of the pixel electrodes in the green subpixels in the horizontal direction are the same, the lengths of the pixel electrodes in the blue subpixels in the horizontal direction are the same, the lengths of the pixel electrodes in the red subpixels in the vertical direction are the same, the lengths of the pixel electrodes in the green subpixels in the vertical direction are the same, and the lengths of the pixel electrodes in the blue subpixels in the vertical direction are the same, so as to improve the display uniformity of the subpixels having a same color.

In at least one embodiment as shown in FIG. 10, a first length W1 represents a length of the pixel electrode in R11 in the horizontal direction, a fourth length W4 represents a length of the pixel electrode in G12 in the horizontal direction, and a fifth length W5 represents a length of the pixel electrode in B13 in the horizontal direction.

In at least one embodiment as shown in FIG. 10, W5 is greater than W1, and W1 is greater than W4. However, the present disclosure is not limited thereto.

As shown in FIG. 11, a blue subpixel B11 in a first row and a first column, a green subpixel G12 in the first row and a second column and a red subpixel R21 in a second row and the first column form a pixel; a red subpixel R13 in the first row and a third column, a blue subpixel B22 in the second row and the second column and a green subpixel G23 in the second row and the third column form a pixel; a blue subpixel B31 in a third row and the first column, a green subpixel G32 in the third row and the second column and a red subpixel R41 in a fourth row and the first column form a pixel; and a red subpixel R33 in the third row and the third column, a blue subpixel B42 in the fourth row and the second column and a green subpixel G43 in the fourth row and the third column form a pixel. R21 and R41 are both electrically coupled to a first data line DT1, B11 and B31 are both electrically coupled to a second data line DT2, G12 and G32 are both electrically coupled to a third data line DT3, and R31 and R33 are both electrically coupled to a fourth data line DT4. The subpixels in the first row are electrically to a first scanning line GT1, the subpixels in the second row are electrically coupled to a second scanning line GT2, the subpixels in the third row are electrically coupled to a third scanning line GT3, and the subpixels in the row are electrically coupled to a fourth scanning line GT4.

In at least one embodiment as shown in FIG. 11, a length of the pixel electrode in each red subpixel in the horizontal direction is greater than a length of the pixel electrode in each blue subpixel in the horizontal direction, and the length of the pixel electrode in each blue subpixel in the horizontal direction is greater than a length of the pixel electrode in each green subpixel in the horizontal direction.

In the pixels, the lengths of the pixel electrodes in the red subpixels in the horizontal direction are the same, the lengths of the pixel electrodes in the green subpixels in the horizontal direction are the same, the lengths of the pixel electrodes in the blue subpixels in the horizontal direction are the same, the lengths of the pixel electrodes in the red subpixels in the vertical direction are the same, the lengths of the pixel electrodes in the green subpixels in the vertical direction are the same, and the lengths of the pixel electrodes in the blue subpixels in the vertical direction are the same, so as to improve the display uniformity of the subpixels having a same color.

In at least one embodiment as shown in FIG. 11, a sixth length W6 represents a length of the pixel electrode in B11 in the horizontal direction, a fourth length W4 represents a length of the pixel electrode in G12 in the horizontal direction, and a seventh length W7 represents a length of the pixel electrode in R13 in the horizontal direction.

In at least embodiment as shown in FIG. 11, W7 is greater than W6, and W6 is greater than W4. However, the present disclosure is limited thereto.

The present disclosure provides in some embodiments a driving method applied to the above-mentioned pixel structure. A display period includes a plurality of driving stages arranged one after another. The driving method includes: at a (2n−1)^{th} driving stage, enabling a (2n−1)^{th} scanning line, and enabling subpixels in a (2n−1)^{th} row to receive a data voltage provided by corresponding data lines; and at a (2n)^{th} driving stage, enabling a (2n)^{th} scanning line, and enabling subpixels in a (2n)^{th} row to receive a data voltage provided by corresponding data lines, where n is a positive integer. At the (2n−1)^{th} driving stage, the data voltage provided by the data lines is a data voltage corresponding to the subpixels in the (2n−1)^{th} row, and at the (2n)^{th} driving stage, the data voltage provided by the data lines is a data voltage corresponding to the subpixels in the (2n)^{th} row.

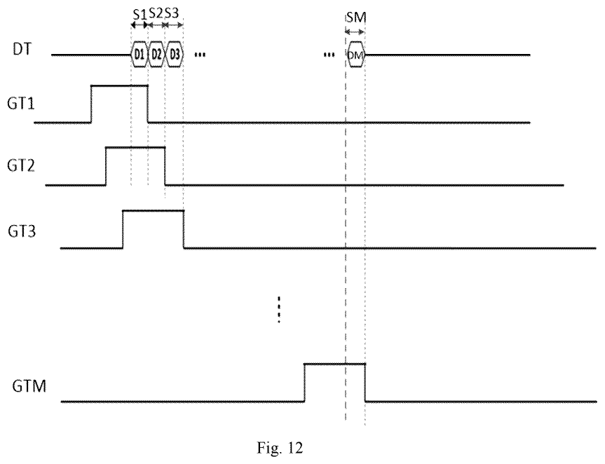

As shown in FIG. 12, in a case that the array substrate in at least one embodiment of the present disclosure includes M rows of subpixels and M scanning lines and the subpixels in an m^{th} row are electrically coupled to an m^{th} scanning line (M is an integer greater than 1 and m is a positive integer smaller than or equal to M), the display period includes a plurality of driving stages arranged one after another. S1 represents a first driving stage, S2 represents a second driving stage, S3 represents a third driving stage, and SM represents an M^{th} driving stage.

At the first driving stage S1, a first scanning line GT1 provides a high voltage signal (at this time, a transistor arranged in a display region and electrically coupled to the pixel electrode is an N-type transistor, and in a case that the transistor arranged in the display region and electrically coupled to the pixel electrode is a P-type transistor, the first scanning line provides a low voltage signal as an on-state voltage of the transistor), a data line DT provides a first data voltage D1, and the subpixels arranged in a first row receive a first data voltage D1.

At the second driving stage S2, a second scanning line GT2 provides a high voltage signal, the data line DT provides a second data voltage D2, and the subpixels arranged in a second row receive a second data voltage D2.

At the third driving stage S3, a third scanning line GT3 provides a high voltage signal, the data line DT provides a third data voltage D3, and the subpixels arranged in a third row receive a third data voltage D3.

At the M^{th} driving stage SM, an M^{th} scanning line GTM provides a high voltage signal, the data line DT provides an M^{th} data voltage DM, and the subpixels arranged in an M^{th} row receive an M^{th} data voltage DM.

In at least one embodiment as shown in FIG. 12, a duration of each driving stage is 1H (a time for charging the subpixels in one row). S1 represents a last time period of 1H included in a high voltage time period of a first scanning signal provided by GT1, S2 represents a non-overlapping time period between the high voltage time period of the first scanning signal provided by GT1 and a high voltage time period of a second scanning signal provided by GT2, S3 represents a non-overlapping time period between the high voltage time period of the second scanning signal provided by GT2 and a high voltage time period of a third scanning signal provided by GT3, and SM represents a non-overlapping time period between a high voltage time period of an (M−1)^{th} scanning signal provided by an (M−1)^{th} scanning line and a high voltage time period of an M^{th} scanning signal provided by an M^{th} scanning time.

In at least one embodiment of the present disclosure, within the high voltage time periods of the scanning signals, a potential of each scanning signal is a high voltage.

The present disclosure provides in some embodiments a driving method applied to the above-mentioned pixel structure, which includes applying scanning signals to a plurality of scanning lines, so that a (2n−1)^{th} scanning signal applied to a (2n−1)^{th} scanning line is the same as a (2n)^{th} scanning signal applied to a (2n)^{th} scanning line. An overlapping time period is included between an active voltage time period of the (2n)^{th} scanning signal and an active voltage time period of a (2n+1)^{th} scanning signal; and within the overlapping time period, the (2n−1)^{th} scanning line, the (2n)^{th} scanning line, a (2n+1)^{th} scanning line and a (2n+2)^{th} scanning line are enabled, and subpixels in a (2n−1)^{th} row, subpixels in a (2n)^{th} row, subpixels in a (2n+1)^{th} row and subpixels in a (2n+2)^{th} row receive a data voltage provided by corresponding data lines, where n is a positive integer.

In the embodiments of the present disclosure, in a case that the pixel structure of the array substrate operates in a dual-line gate (DLG) mode, the subpixels electrically coupled to a same data line have a same color, so it is able to prevent the occurrence of a color abnormality for an image in a frequency doubling mode, increase a charging time of at least a part of subpixels, and increase a charging rate and a refresh rate, thereby to improve the display quality.

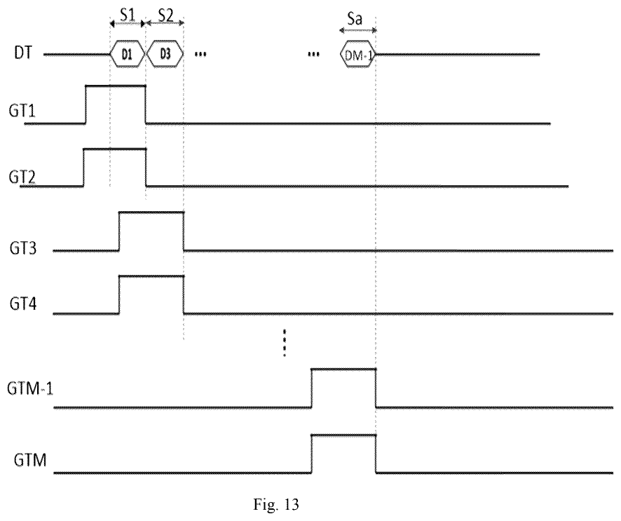

As shown in FIG. 13, in a case that the array substrate in at least one embodiment of the present disclosure includes M rows of subpixels and M scanning lines and the subpixels in an m^{th} row are electrically coupled to an m^{th} scanning line (M is an integer greater than 1 and m is a positive integer smaller than or equal to M), a first scanning signal provided by a first scanning line GT1 is the same as a second scanning signal provided by a second scanning line GT2, a third scanning signal provided by a third scanning line GT3 is the same as a fourth scanning signal provided by a fourth scanning line GT4, and an (M−1)^{th} scanning signal provided by an (M−1)^{th} scanning line is the same as an M^{th} scanning signal provided by an M^{th} scanning line.

A display period includes a plurality of driving stages arranged one after another. S1 represents a first driving stage, S2 represents a second driving stage, and SM represents an M^{th} stage. The first driving stage S1 represents an overlapping time period between a high voltage time period of the second scanning signal and a high voltage time period of the third scanning signal, the second driving stage S2 represents an overlapping time period between a high voltage time period of the fourth scanning and a high voltage time period of a fifth scanning signal provided by a fifth scanning line, and an a^{th} driving stage Sa represents a last time period of 2H included in the M^{th} scanning signal (where a is a positive integer).

At the first driving stage S1, a data line DT provides a first data voltage D1, GT1, GT2, GT3 and GT4 are enabled, and the subpixels in a first row, the subpixels in a second row, the subpixels in a third row and the subpixels in a fourth row are enabled, to receive the first data voltage D1.

At the first driving stage S2, the data line DT provides a third data voltage D3, GT3, GT4, the fifth scanning line and a sixth scanning line are enabled, and the subpixels in the third row, the subpixels in the fourth row, the subpixels in a fifth row and the subpixels in a sixth row are enabled, to receive the third data voltage D3.

At the a^{th} driving stage Sa, the data line DT provides an (M−1)^{th} data voltage DM-1, GTM-1 and GTM are enabled, and the subpixels in an (M−1)^{th} row and the subpixels in an (M)^{th} row are enabled, to receive the (M−1)^{th} data voltage DM-1.

In at least one embodiment as shown in FIG. 13, a duration of each driving stage is 2H. A data voltage received by the subpixels in the (2n−1)^{th} row is the same as a data voltage received by the subpixels in the (2n)^{th} row. The data voltage received by the subpixels in the (2n−1)^{th} row and the subpixels in the (2n)^{th} row is a (2n−1)^{th} data voltage or a (2n)^{th} data voltage, or an average value of the (2n−1)^{th} data voltage and the (2n)^{th} data voltage.

The present disclosure provides in some embodiments a driving method applied to the above-mentioned array substrate, which includes applying scanning signals to a plurality of scanning lines to control the plurality of scanning lines to be enabled sequentially within a display period. Within the display period, an overlapping time period and a non-overlapping period are included between active time periods of the scanning signals applied to at least two adjacent scanning lines in the plurality of scanning lines enabled sequentially; and a data voltage applied to a data line within at least a part of the overlapping time period is the same as a data voltage applied to the data line within at least a part of the non-overlapping time period.

In the embodiments of the present disclosure, in a case that a pixel structure of the array substrate operates in a Hardware Super Resolution (HSR) mode, the subpixels electrically coupled to a same data line have a same color, so it is able to prevent the occurrence of a color abnormality for an image in a frequency doubling mode, increase a charging time of at least a part of subpixels, and increase a charging rate and a refresh rate, thereby to improve the display quality.

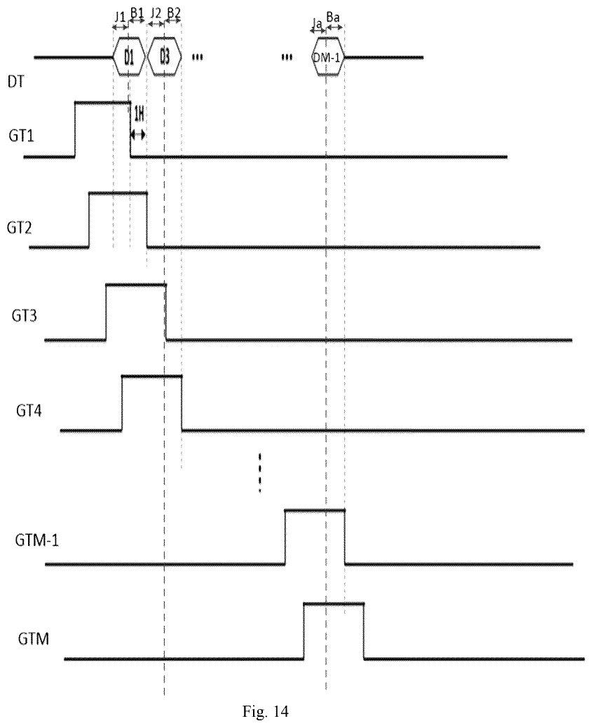

As shown in FIG. 14, in a case that the array substrate in at least one embodiment of the present disclosure includes M rows of subpixels and M scanning lines and the subpixels in an m^{th} row are electrically coupled to an m^{th} scanning line (M is an integer greater than 1 and m is a positive integer smaller than or equal to M), the display period includes a first overlapping time period J1 (e.g., 1H), a first non-overlapping time period B1 (e.g., 1H), a second overlapping time period J2 (e.g., 1H), a second non-overlapping time period B2 (e.g., 1H), an a^{th} overlapping time period Ja and an a^{th} non-overlapping time period B1 (where a is a positive integer). Here, the overlapping time period refers to a part of a time period within which adjacent gate lines are enabled simultaneously, and the non-overlapping time period refers to a part of a time period within which adjacent gate lines are enabled sequentially, i.e., a gate line is disabled and then an adjacent gate line is enabled.

Within the first overlapping time period J1, a data line DT provides a first data voltage D1, GT1 and GT2 are enabled, and the subpixels in a first row and a second row receive the first data voltage D1.

Within the first non-overlapping time period B1, the data line DT provides the first data voltage D1, GT2 is enabled, and the subpixels in the second row receive the first data voltage D1, i.e., the subpixels in adjacent rows receive a same data voltage within the first overlapping time period and the first non-overlapping time period.

Within the second overlapping time period J2, the data line DT provides a third data voltage D3, GT3 and GT4 are enabled, and the subpixels in a third row and a fourth row receive the third data voltage D3.

Within the second non-overlapping time period B2, the data line DT provides the third data voltage D3, GT4 is enabled, and the subpixels in the fourth row receive the third data voltage D3.

Within the a^{th} overlapping time period Ja, the data line DT provides an (M−1)^{th} data voltage DM-1, GTM-1 and GTM are enabled, the subpixels in an (M−1)^{th} row and an M^{th} row are enabled, and the subpixels in the (M−1)^{th} row and the M^{th} row receive the (M−1)^{th} data voltage DM-1.

Within the a^{th} non-overlapping time period Ba, the data line DT provides the (M−1)^{th} data voltage DM-1, GTM is enabled, the subpixels in the M^{th} row are enabled, and the subpixels in M^{th} row receive the (M−1)^{th} data voltage DM-1.

In at least one embodiment as shown in FIG. 14, J1 represents a partial overlapping time period between a high voltage time period of a first scanning signal and a high voltage time period of a second scanning signal, B1 represents a partial non-overlapping time period between the high voltage time period of the first scanning signal and the high voltage time period of the second scanning signal, J2 represents a partial overlapping time period between a high voltage time period of a third scanning signal and a high voltage time period of a fourth scanning signal, B2 represents a partial non-overlapping time period between the high voltage time period of the third scanning signal and the high voltage time period of the fourth scanning signal, Ja represents a partial overlapping time period between a high voltage time period of an (M−1)^{th} scanning signal and a high voltage time period of an M^{th} scanning signal, and Ba represents a partial overlapping time period between the high voltage time period of the (M−1)^{th} scanning signal and the high voltage time period of the M^{th} scanning signal.

Pixel architecture in the embodiments of the present disclosure may be applied to such a pixel display mode as Twisted Nematic (TN), In-Plane Switching (IPS), Advanced Super Dimension Switch (ADS)/Fringe Field Switching (FFS), or Vertical Alignment (VA).

The pixel architecture in the embodiments of the present disclosure may be applied to such a back plate process as a-Si, Oxide, Low Temperature Poly-Silicon (LTPS), or Low Temperature Polycrystalline Oxide (LTPO).

The present disclosure provides in some embodiments a display device, which includes the above-mentioned array substrate.

The above are merely the preferred embodiments of the present disclosure. It should be appreciated that, a person skilled in the art may further make improvements and modifications without departing from the principle of the present disclosure, and these improvements and modifications shall also be considered as the scope of the present disclosure.

1. An array substrate, comprising a plurality of scanning lines extending in a first direction, a plurality of data lines extending in a second direction, and a plurality of pixels, wherein the pixel comprises at least three subpixels having different colors;
one of the plurality of scanning lines is arranged between two adjacent rows of subpixels, and one of the plurality of data lines is arranged between two adjacent columns of subpixels;
in two adjacent rows of subpixels, two subpixels electrically coupled to a same data line have a same color, and the two subpixels are electrically coupled to different scanning lines;
the subpixel comprises a pixel electrode; and
a length of the pixel electrode in the first direction is greater than a length of the pixel electrode in the second direction.

2. The array substrate according to claim 1, wherein a ratio of the length of the pixel electrode in the first direction to the length of the pixel electrode in the second direction is greater than 1 and smaller than or equal to 2.

3. The array substrate according to claim 1, wherein a ratio of the length of the pixel electrodes in two adjacent rows and columns in the first direction to the length of the pixel electrodes in the two adjacent rows and columns in the second direction is greater than or equal to 1.2 and smaller than or equal to 1.8.

4. The array substrate in claim 1, wherein the pixel electrodes in at least two subpixels of a same pixel have different lengths in the first direction.

5. The array substrate according to claim 4, wherein the pixel electrodes in the subpixels of different pixels having a same color have a same length in the first direction; and
the pixel electrodes in the subpixels of different pixels having a same color have a same length in the second direction.

6. The array substrate according to claim 1, wherein the pixel comprises three subpixels having different colors; and
two subpixels of the three subpixels of the pixel are arranged in a (2n−1)^{th} row, and a subpixel of the pixel other than the two subpixels is arranged in a (2n)^{th} row, where n is a positive integer.

7. The array substrate according to claim 6, wherein a subpixel in the (2n−1)^{th} row and a (3m−2)^{th} column, a subpixel in the (2n−1)^{th} row and a (3m−1)^{th} column and a subpixel in the (2n)^{th} row and the (3m−2)^{th} column form a pixel;
a subpixel in the (2n−1)^{th} row and a (3m)^{th} column, a subpixel in the (2n)^{th} row and the (3m−1)^{th} column and a subpixel in the (2n)^{th} row and the (3m)^{th} column form a pixel;
the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n)^{th} row and the (3m−2)^{th} column is electrically coupled to a (2n)^{th} scanning line and a (3m−2)^{th} data line; and
the subpixel in the (2n−1)^{th} row and the (3m)^{th} column is electrically coupled to the (2n−1)^{th} scanning line and a (3m+1)^{th} data line, the subpixel in the (2n)^{th} row and the (3m−1)^{th} column is electrically coupled to the (2n)^{th} scanning line and the (3m−1)^{th} data line, and the subpixel in the (2n)^{th} row and the (3m)^{th} column is electrically coupled to the (2n)^{th} scanning line and the (3m)^{th} data line, where m is a positive integer.

8. The array substrate according to claim 7, wherein the subpixel in the (2n−1)^{th} row and the (3m−2)^{th} column is a red subpixel, the subpixel in the (2n−1)^{th} row and the (3m−1)^{th} column is a green subpixel, and the subpixel in the (2n)^{th} row and the (3m−2)^{th} column is a blue subpixel; and
the subpixel in the (2n−1)^{th} row and the (3m)^{th} column is a blue subpixel, the subpixel in the (2n)^{th} row and the (3m−1)^{th} column is a red subpixel, and the subpixel in the (2n)^{th} row and the (3m)^{th} column is a green subpixel.

9. The array substrate according to claim 7, wherein the subpixel in the (2n−1)^{th} row and the (3m−2)^{th} column is a red subpixel, the subpixel in the (2n−1)^{th} row and the (3m−1)^{th} column is a blue subpixel, and the subpixel in the (2n)^{th} row and the (3m−2)^{th} column is a green subpixel; and
the subpixel in the (2n−1)^{th} row and the (3m)^{th} column is a green subpixel, the subpixel in the (2n)^{th} row and the (3m−1)^{th} column is a red subpixel, and the subpixel in the (2n)^{th} row and the (3m)^{th} column is a blue subpixel.

10. The array substrate according to claim 7, wherein the subpixel in the (2n−1)^{th} row and the (3m−2)^{th} column is a blue subpixel, the subpixel in the (2n−1)^{th} row and the (3m−1)^{th} column is a red subpixel, and the subpixel in the (2n)^{th} row and the (3m−2)^{th} column is a green subpixel; and
the subpixel in the (2n−1)^{th} row and the (3m)^{th} column is a green subpixel, the subpixel in the (2n)^{th} row and the (3m−1)^{th} column is a blue subpixel, and the subpixel in the (2n)^{th} row and the (3m)^{th} column is a red subpixel.

11. The array substrate according to claim 1, wherein the at least three subpixels of the pixel having different colors are arranged in a same row.

12. The array substrate according to claim 11, wherein the pixel comprises three subpixels having different colors; a subpixel in a (2n−1)^{th} row and a (3m−2)^{th} column, a subpixel in the (2n−1)^{th} row and a (3m−1)^{th} column and a subpixel in the (2n−1)^{th} row and a (3m)^{th} column form a pixel;
a subpixel in a (2n)^{th} row and the (3m−1)^{th} column, a subpixel in the (2n)^{th} row and the (3m)^{th} column and a subpixel in the (2n)^{th} row and a (3m+1)^{th} column form a pixel;
the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n−1)^{th} row and the (3m)^{th} column is electrically coupled to the (2n−1)^{th} scanning line and a (3m+1)^{th} data line; and
the subpixel in the (2n)^{th} row and the (3m−1)^{th} column is electrically coupled to a (2n)^{th} scanning line and the (3m−1)^{th} data line, the subpixel in the (2n)^{th} row and the (3m)^{th} column is electrically coupled to the (2n)^{th} scanning line and the (3m)^{th} data line, and the subpixel in the (2n)^{th} row and the (3m+1)^{th} column is electrically coupled to the (2n)^{th} scanning line and the (3m+1)^{th} data line, where n and m are both positive integers.

13. The array substrate according to claim 12, wherein the subpixel in the (2n−1)^{th} row and the (3m−2)^{th} column has a same color as the subpixel in the (2n)^{th} row and the (3m−1)^{th} column;
the subpixel in the (2n−1)^{th} row and the (3m−1)^{th} column has a same color as the subpixel in the (2n)^{th} row and the (3m)^{th} column; and
the subpixel in the (2n−1)^{th} row and the (3m)^{th} has a same color as the subpixel in the (2n)^{th} row and the (3m+1)^{th} column.

14. The array substrate according to claim 11, wherein the pixel comprises three subpixels having different colors;
a subpixel in a (2n−1)^{th} row and a (3m−2)^{th} column, a subpixel in the (2n−1)^{th} row and a (3m−1)^{th} column and a subpixel in the (2n−1)^{th} row and a (3m)^{th} column form a pixel;
a subpixel in a (2n)^{th} row and the (3m)^{th} column, a subpixel in the (2n)^{th} row and a (3m+1)^{th} column and a subpixel in the (2n)^{th} row and a (3m+2)^{th} column form a pixel;
the subpixel in the (2n−1)^{th} row and the (3m−2)^{th} column is electrically coupled to a (2n−1)^{th} scanning line and a (3m−1)^{th} data line, the subpixel in the (2n−1)^{th} row and the (3m−1)^{th} column is electrically coupled to the (2n−1)^{th} scanning line and a (3m)^{th} data line, and the subpixel in the (2n−1)^{th} row and the (3m)^{th} column is electrically coupled to the (2n−1)^{th} scanning line and a (3m+1)^{th} data line; and
the subpixel in the (2n)^{th} row and the (3m)^{th} column is electrically coupled to a (2n)^{th} scanning line and the (3m)^{th} data line, the subpixel in the (2n)^{th} row and the (3m+1)^{th} column is electrically coupled to the (2n)^{th} scanning line and the (3m+1)^{th} data line, and the subpixel in the (2n)^{th} row and the (3m+2)^{th} column is electrically coupled to the (2n)^{th} scanning line and a (3m+2)^{th} data line, where n and m are both positive integers.

15. The array substrate according to claim 14, wherein the subpixel in the (2n−1)^{th} row and the (3m−2)^{th} column has a same color as the subpixel in the (2n)^{th} row and the (3m)^{th} column;
the subpixel in the (2n−1)^{th} row and the (3m−1)^{th} column has a same color as the subpixel in the (2n)^{th} row and the (3m+1)^{th} column; and
the subpixel in the (2n−1)^{th} row and the (3m)^{th} has a same color as the subpixel in the (2n)^{th} row and the (3m+2)^{th} column.

16. A driving method, applied to the array substrate according to claim 1, wherein a display period comprises a plurality of driving stages arranged one after another, wherein the driving method comprises:
at a (2n−1)^{th} driving stage, enabling a (2n−1)^{th} scanning line, and enabling subpixels in a (2n−1)^{th} row to receive a data voltage provided by corresponding data lines; and
at a (2n)^{th} driving stage, enabling a (2n)^{th} scanning line, and enabling subpixels in a (2n)^{th} row to receive a data voltage provided by corresponding data lines, where n is a positive integer;
wherein at the (2n−1)^{th} driving stage, the data voltage provided by the data lines is a data voltage corresponding to the subpixels in the (2n−1)^{th} row, and at the (2n)^{th} driving stage, the data voltage provided by the data lines is a data voltage corresponding to the subpixels in the (2n)^{th} row.

17. A driving method, applied to the array substrate according to claim 1, comprising applying scanning signals to a plurality of scanning lines, so that a (2n−1)^{th} scanning signal applied to a (2n−1)^{th} scanning line is the same as a (2n)^{th} scanning signal applied to a (2n)^{th} scanning line,
wherein an overlapping time period is comprised between an active voltage time period of the (2n)^{th} scanning signal and an active voltage time period of a (2n+1)^{th} scanning signal; and
within the overlapping time period, the (2n−1)^{th} scanning line, the (2n)^{th} scanning line, a (2n+1)^{th} scanning line and a (2n+2)^{th} scanning line are enabled, and subpixels in a (2n−1)^{th} row, subpixels in a (2n)^{th} row, subpixels in a (2n+1)^{th} row and subpixels in a (2n+2)^{th} row receive a data voltage provided by corresponding data lines, where n is a positive integer.

18. A driving method, applied to the array substrate according to claim 1, comprising applying scanning signals to a plurality of scanning lines to control the plurality of scanning lines to be enabled sequentially within a display period,
wherein within the display period, an overlapping time period and a non-overlapping period are comprised between active time periods of the scanning signals applied to at least two adjacent scanning lines in the plurality of scanning lines enabled sequentially; and
a data voltage applied to a data line within at least a part of the overlapping time period is the same as a data voltage applied to the data line within at least a part of the non-overlapping time period.

19. A display device, comprising the array substrate according to claim 1.

20. The display device according to claim 19, wherein a ratio of the length of the pixel electrode in the first direction to the length of the pixel electrode in the second direction is greater than 1 and smaller than or equal to 2.
